(19) United States
(12) Patent Application Publication
(10) Pub. No.: US 2003/0170543 A1
(43) Pub. Date: Sep. 11, 2003

(54) Zinc fibers, zinc anodes and methods of making zinc fibers

(75) Inventors: Jon W. Headrick, Greeneville, TN (US); Lynn Payne, Greeneville, TN (US); Johnny Smelcer, Midway, TN (US); Derek Tarrant, Greeneville, TN (US); James Dyer, Greeneville, TN (US)

Correspondence Address: James D. Wood, Ice Miller, One American Square, Box 82001, Indianapolis, IN, 46282-0002, US

(73) Assignee: Alltrista Zinc Products Company, L.P., Greeneville, TN

(21) Appl. No.: 10/083,196

(22) Filed: Feb. 26, 2002

(51) Int. Cl. H01M 4/80; H01M 4/42

(52) U.S. Cl. 429/235; 429/229

(57) ABSTRACT

The present invention comprises a method of making metallic fibers and electrodes. The metallic fibers are manufactured by milling a stock piece of material, preferably with a computer number controlled (CNC) milling machine. According to one embodiment, the length of the fibers is determined by the width of the stock material and stock material may be stacked so as to produce a number of fibers. According to another embodiment, the cutting tool comprises chip breakers which determine the length of the fibers. Zinc fibers made according to the present invention may be used to manufacture battery electrodes by compressing the fibers into the desired shape and porosity.

### FIELD OF THE INVENTION

This invention relates to metallic fibers and to the production of metal fibers and the like for use in various applications and, in particular, to a novel method of making zinc fibers and using those fibers in the manufacture of electrodes.

### BACKGROUND OF THE INVENTION

Zinc has many useful properties which make it advantageous for use in a number of industrial applications. Zinc is often used in electrochemical power production (as an anode or cathode in a battery cell). Zinc is also useful for filtering various undesired materials such as mercury or acid. Zinc has also been used as a biostat and fungistat, and for cathodic protection. The efficacy of zinc in all of these applications, however, depends upon the amount of zinc surface area. Thus, generally, it is advantageous to realize an increase in surface area of the zinc used in the application.

With respect to use in electrochemical cells, the surface area of the zinc in the anode of the cell is critical. Typical electrochemical cells comprise a positive electrode, a negative electrode, and an alkaline electrolyte. The positive electrode may be formed as a hollow cylinder with its outer surface contacting the inner surface of a cell housing shaped as a can. A separator is disposed within the inside of the positive electrode to provide physical separation from the negative electrode. The separator, however, allows ions to move through it, with the movement of ions critical for the chemical reactions which result in the flow of current between the anode and the cathode.

The negative electrode, or anode, may be made by suspending zinc within the alkaline electrolyte. The zinc is in electrical connectivity with a collector assembly. When a connection is made between the positive and negative electrodes, a chemical reaction occurs between the electrolyte and the zinc which produces an electric current. This reaction is known as an oxidation-reduction (redox) reaction. The redox reaction rate is a function of the circuit resistance on the cell, and the amount of current produced in a given area at the zinc/electrolyte interface is referred to as the surface current density.

In zinc alkaline batteries, the redox reaction consumes the zinc anode material and converts it to zinc oxide/hydroxide. Initially, the zinc oxide/hydroxide dissolves into the electrolyte. As the redox reaction proceeds the amount of zinc oxide/hydroxide produced or the rate of production may exceed the amount that can be dissolved or held by the electrolyte. In this case, the excess zinc oxide/hydroxide precipitates out of solution and deposits and accumulates onto the zinc in the anode. As it accumulates, it blocks the redox reaction by forming a barrier between the electrolytic solution and the remaining zinc. The accumulation of these deposits decreases the power capacity of the battery significantly, particularly for a high rate of current demand on the cell, where the surface current density is high.

The decrease of power capacity is known as passivation. Passivation can be aggravated by low electrolyte temperature. At lower temperatures, the electrolyte is not able to hold as much zinc oxide in solution as can be held in solution at higher temperatures. Thus, even at low reaction rates, more zinc oxide/hydroxide can be produced than can be held in solution. The “excess” zinc oxide/hydroxide deposits on the zinc itself, quickly blocking further redox reaction. However, passivation due to low temperature can be reduced by presenting a higher surface area of zinc. For a given amount of zinc oxide/hydroxide deposited, a larger surface area will reduce the deleterious effects of the blocked localized reactions. Thus, with all other factors being equal the higher the surface area of the zinc in the anode the better the overall performance of the alkaline cell.

Passivation is also aggravated by having a low surface area of zinc in the anode for a given current discharge rate. As the surface area of zinc available for the redox reaction decreases, surface current densities necessarily increase. Thus, the localized rate of production of zinc oxide/hydroxide eventually surpasses the rate at which the zinc oxide can be dissolved into the electrolyte. Accordingly, the “excess” zinc oxide/hydroxide deposits on the zinc, blocking further localized reaction. This mechanism of passivation can be dramatically reduced by providing increased surface area which lowers the surface current density thus lowering localized rate of production of zinc oxide. Moreover, for a given amount of zinc oxide/hydroxide deposited, a larger surface area will reduce the deleterious effects of the blocked localized reactions.

Passivation is of particular concern when a high rate of current discharge is demanded from the battery. Under normal discharge conditions, the redox reaction “consumes” potassium hydroxide molecules at the zinc/electrolyte interface, resulting in a lower concentration of potassium hydroxide in the electrolyte at the zinc/electrolyte interface. However, molecules in solution tend to move within the solution to provide a uniform distribution of molecules throughout the solution. Thus, the potassium hydroxide in the electrolyte migrates from areas of higher concentration to the areas of lower concentration. This results in a constant supply of potassium hydroxide molecules at the zinc/electrolyte interface for further reactions. A similar process occurs to move the zinc oxide/hydroxide molecules in solution away from the zinc in the anode and toward the cathode.

A high rate of current discharge forces the process out of equilibrium. As discussed above, to supply a large amount of current, it is necessary to have high surface current density. The increased reaction rate required to provide the high surface current density creates a localized condition of a low amount of potassium hydroxide and high amount of zinc oxide/hydroxide. There is, however, a relatively high amount of potassium hydroxide and low amount of zinc oxide/hydroxide within the pores of the cathode. Thus, as discussed above, the zinc oxide/hydroxide molecules attempt to travel toward the cathode while potassium hydroxide molecules attempt to migrate toward the anode.

The problem arises at the separator which divides the cathode material from the anode material. In normal operation, zinc oxide/hydroxide and potassium hydroxide molecules pass freely through the porous separator, thus maintaining an even concentration of molecules throughout the electrolyte. This process breaks down under a high rate of current discharge since more molecules are attempting to pass through the porous separator than can be efficiently passed. Thus, the separator acts as a dam on the molecules, and an increase in the concentration of molecules results in a precipitation of zinc oxide/hydroxide molecules near the separator, which restricts the flow of potassium hydroxide to the anode, hindering additional redox reactions. In this situation, increased surface area of zinc is beneficial since a lower concentration of potassium hydroxide in solution is needed to generate the requisite surface current density. In addition or as an alternative, increased electrolyte loading in the anode area can supply the required potassium hydroxide molecules.

Accordingly, it is well known to use zinc in the form of a powder in the manufacture of battery anodes since small particles provide the greatest surface area for a given mass of zinc. U.S. Patent Application No. US2001/0009741 A1, published Jul. 26, 2001, of Durkot et al., discloses the use of very small zinc particles (fine particles or dust) dispersed amongst zinc-based particles in the anode of an alkaline electrochemical cell to improve the operating characteristics of the cell. According to that patent, the use of the fine particles reduces the total zinc loading needed to achieve a given level of cell performance due to the increased surface area achieved in using particles rather than a solid mass.

However, the use of zinc powder does present certain challenges. Specifically, the zinc must be in electrical connectivity with the cell collector assembly. However, zinc powder does not maintain a stable connectivity unless it is greatly compressed. Obviously, the compression of zinc powder results in a loss of surface area. Accordingly, several approaches have been used to eliminate the need for high levels of compression of powder while providing for the requisite stable connectivity.

One approach is to use zinc suspended in a gelatinous agent. The gelatinous agent, which also functions as the electrolyte, provides for the requisite stable connectivity. U.S. Pat. No. 6,022,639 to Urry discloses the use of particles in the form of flakes with a gelling agent. Nonetheless, it would be more advantageous if a suspension agent were not needed since the gel displaces the electrolyte, and interferes with ion transport, leading to passivation problems as discussed above. Moreover, by decreasing the amount of suspension agent or gelling agent required, the battery design is simplified and costs are reduced. Another drawback to using zinc powder is its relative cost. The world is undergoing a battery-grade zinc powder shortage that drives the relative cost of zinc powder up. Thus, zinc powder is more expensive when compared with non-powdered zinc.

Another shortcoming in the use of zinc powder as the anode in alkaline cells is the wasted amount of zinc. When an alkaline battery having a zinc powder anode is completely discharged at high discharge rates and is “autopsied”, it is observed that only approximately 50% of the zinc powder has been consumed by the redox reaction. The reaction of the balance of the zinc powder has been inhibited by disruption of inter-particle electrical contact by the deposits of zinc oxide/hydroxide. This leaves a significant amount of zinc powder in the battery which was not utilized to produce power. The loss of useful zinc surface area reduces useful cell life. This wasted zinc also drives up the costs of alkaline batteries in two ways. First, larger amounts of zinc powder are required to achieve the same amount of battery output. Second, the unused zinc displaces electrolyte. Increasing the amount of electrolyte for a given battery volume would allow the manufacturers to increase the battery's capacity.

An alternative to using particles or flakes suspended in a gelatinous agent is to use zinc fibers. The fibers can provide increased strength and resiliency without sacrificing the requisite stable connectivity. U.S. Pat. No. 3,071,638 to Clark et al. discloses a method of producing high efficiency, high current density zinc electrodes from electrochemically deposited zinc. According to this patent, the zinc fibers produced are dendritic in nature. The dendritic particles are then pressed into a copper screen which provides for the requisite stable connectivity. This method produces a very efficient anode. However, the process is obviously quite complicated, requiring a complicated, expensive and time-consuming electro-deposition process. Moreover, the size of the fibers is limited by the process.

Another process for forming fibers is disclosed in U.S. Pat. No. 5,827,997 to Chung et al. According to this patent, a metal such as zinc is electroplated onto a carbon core filament. Accordingly, this process is still complicated and uses an expensive and time-consuming electro-deposition process.

U.S. Pat. No. 5,584,109 to DiGiovanni et al. discloses an improved battery plate made from metallic fibers of a single or plural diameter. According to this patent, the metal fibers are produced by cladding and drawing a plurality of metallic wires to form a fiber tow. The fiber tow is then severed to produce fiber tows of the desired length. The fiber tows are then randomly spread into a mat and sintered to provide an electrically conductive battery plate with a multiplicity of pores with high strength. The patent notes that the use of metallic fibers in a battery plate as disclosed therein provides a number of advantages over other battery plates. However, the extensive processing of metal to produce fiber tow significantly increases the manufacturing costs associated with producing the battery plates.

U.S. Pat. No. 5,226,210 to Koskenmaki et al. discloses another method for producing metallic fibers. The '210 patent discloses a mat of randomly oriented fibers produced by squirting a fine stream of molten metal from one or more orifices into the atmosphere. The molten metal then solidifies as strands. The pressure applied to the molten metal, in conjunction with the orifice size, determines whether the resulting fiber or strand is generally straight or generally curled. The '210 patent also discloses a method of embedding the strands into a polymeric substrate to form a composite mat. The production of fibers according to the '210 patent thus requires specialized facilities to first melt the metal, and to then put the metal under extreme pressure so as to force it through a small orifice. Moreover, the steps of melting and pressurizing the metal adds significantly to the time and the production costs associated with producing these fibers.

U.S. Pat. No. 5,158,643 to Yoshinaka et al. discloses the formation of zinc oxide whiskers from an atmosphere comprising zinc steam. According to the '643 patent, zinc is heated until it reaches a three phase point, that is a temperature and pressure combination at which zinc is present in solid, vapor (steam) and liquid form. A controlled amount of oxygen is then introduced into the zinc steam so as to form zinc whiskers. This process requires specialized equipment which can heat the zinc to the appropriate temperature and then introduce precise amounts of oxygen so as to form the whiskers.

Other processes for producing zinc fibers or wool include shaving a zinc wire or using a lathe to shave the edge of a coil. As noted above, working a piece of stock metal into a finished coil or wire increases the cost of the resulting fiber. Thus, both of these methods are expensive and have low output rates.

What is therefore desired is a simple and inexpensive method of manufacture of zinc fibers. It is desired that the method would allow for high levels of output. It is also desired that the size of the fibers be controllable within a broad range of sizes. It is further preferred that the zinc fibers be of consistent fiber size. It is advantageous if the method does not require the additional costs associated with heating the zinc to or near melting temperature. Finally, it is preferred that the method use stock metal so as to avoid additional costs associated with working the stock metal into another form.

### SUMMARY OF THE INVENTION

The present invention provides a novel method of manufacturing zinc fibers which can be utilized in a number of industrial applications. In one embodiment, fibers are produced according to the present invention by using a Computer Numerically Controlled (CNC) three-axis milling machine. The milling machine has a cutting tool or end mill movable in the X, and Y plane relative to a piece of stock material mounted on the table of the machine. Motors control the motion of the cutting tool in the X and Y directions as well as the Z direction so as to establish an orthogonal X, Y, Z Cartesian coordinate system. A canned cycle program controls the cutting tool position and rotational speed so as to control the movement of the cutting tool around the stock material. Thus, fibers can be milled from a block of stock metal such as zinc. The size of the fibers is precisely controlled by the parameters input into the CNC and the tool used. The length of the fibers is controlled in one embodiment by controlling the depth of cut of the cutting tool in the Z plane or, in another embodiment of the present invention, by stacking sheets of zinc, the thickness of the sheets in the Z plane being the desired length of the fiber.

The invention provides a method of producing zinc fibers which is simple and inexpensive. It is an advantage that the method allows for high levels of output of fibers which can be controlled within a broad range of sizes. It is further advantageous that the controlled zinc fibers are of consistent fiber size. Additionally, the method does not require the additional costs of heating the zinc to or near melting temperature. Furthermore, the method uses stock metal, avoiding the expense of working the stock metal into another form.

Fibers manufactured in accordance with the present invention are easily formed into a variety of shapes for use as electrodes in electrochemical cells. Electrodes formed from fibers made according to the present invention provide a high amount of surface area for the amount of metal used. Electrodes formed according to the present invention also have excellent porosity, allowing for intimate contact with electrolytic solution and for the free flow of ions. It is an advantage that the use of fibers in an electrode results in improved conductivity and stable connectivity within the electrode without the need for using a suspension agent or gel.

### BRIEF DESCRIPTION OF THE DRAWINGS

FIG. 1 shows a cross-sectional view of an electrochemical cell employing zinc fibers in the anode according to the present invention.

FIG. 2 is a perspective view of a three axis CNC milling machine and work piece.

FIG. 3 is a perspective view of a fiber made according to the present invention.

FIG. 4 is an elevational view of a cutting tool.

FIG. 5 is a perspective view of the three axis CNC milling machine and work piece of FIG. 2 with the cutting tool rotated forty-five degrees.

FIG. 6 is a perspective view of a fiber made according to the present invention and a fiber straightened to show the dimensions of the fiber.

FIG. 7 is a macrograph of three fibers according to the present invention.

FIG. 8 is an elevational view of an alternative cutting tool.

FIG. 9 is a developed plan view of the cutting tool of FIG. 8 illustrating the cutting edges, flutes and notches in the cutting tool.

FIG. 10 is a macrograph of fibers according to the present invention after the fibers have been compressed in a mold.

### DETAILED DESCRIPTION

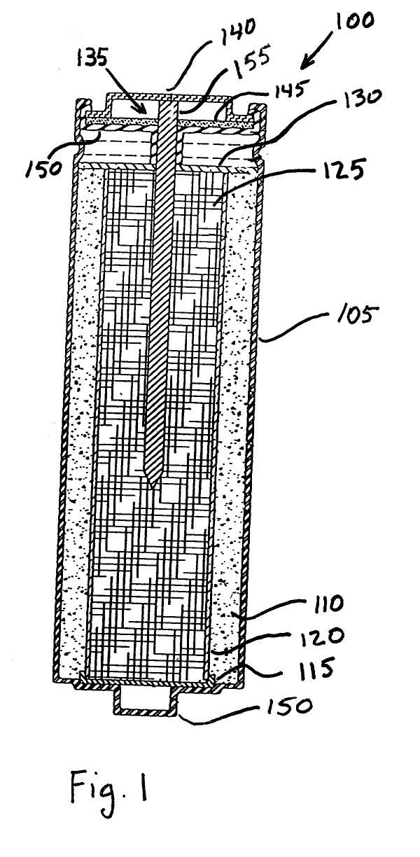

Referring to FIG. 1, electrochemical cell 100 includes cylindrical housing 105 in which positive electrode 110 is located adjacent the inner sidewalls of cell housing 105. Positive electrode 110 is shaped as a hollow cylinder that may be impact molded inside of housing 105 or inserted as a plurality of rings after molding. In a typical alkaline cell, positive electrode 110 is made primarily of manganese dioxide (MnO₂). Cell 100 further includes paper cup 115 and separator paper 120 that lines the inner walls of the hollow cavity within positive electrode 110. Negative electrode 125, which comprises fibers manufactured in accordance with the present invention, is deposited within the hollow cavity of positive electrode 110. An alkaline electrolyte, such as potassium hydroxide (KOH), is also dispensed within the lined hollow cavity of positive electrode 110. Paper cap 130, along with paper cup 115 and separator paper 120 provide for isolation of positive electrode 110 from negative electrode 125.

Cell 100 is closed and sealed by collector assembly 135 and an outer terminal cover 140. Collector assembly 135 includes inner cover 145, insulator 150 and current collector 155. Inner cover 145, current collector 155 and outer terminal cover 140 are electrically coupled. Insulator 150 insulates the rest of collector assembly 135 from cylindrical housing 105. Cylindrical housing 105 is electrically coupled to positive electrode 110 and positive electrode cover 150.

Although positive electrode 110 in the embodiment of FIG. 1 is in the shape of a hollow cylinder, those of skill in the art will recognize that the fibers produced according to the present invention may be used in a number of shapes. By way of example, but not of limitation, fibers manufactured according to the present invention may be formed into electrodes for use in button, cylindrical, wafer, rectangular and flat cells.

It is known in the milling art to use CNC milling machines to finely shape a piece of stock material. One example of a CNC system is disclosed in U.S. Pat. No. 4,591,771. The '771 patent discloses a five-axis CNC machine which allows a machine tool to be moved manually in the axial direction of the machine tool relative to the work piece while maintaining the tool axis direction relative to a table or a work piece. More complicated controls are also known, such as U.S. Pat. No. 5,604,677 which discloses a multi-axis CNC machine. Accordingly, complex shapes can be manufactured with great precision.

It has been discovered, that CNC machines can be programmed so as to create metallic fibers of a consistent length, width and depth. Typically, programming of CNC machines is primarily directed to the path that the cutting tool takes relative to the stock material. The speed of the relative motion of the tool is of concern only to the extent that the cutting tool becomes dull prematurely or binds. For example, U.S. Pat. No. 3,736,634 discloses a cutting tool which is notched so as to create small chips. The creation of smaller chips, according to the '634 patent, allows for greater feed rates and greater rotational rates with less wear on the cutting tool.

The present invention utilizes the fine control available with a CNC milling machine along with a novel method of determining the CNC input parameters and tool parameters to produce metallic fibers of consistent length, width and depth. Input parameters for a typical CNC milling machine include desired travel path including distance and direction, speed of cutting tool rotation, feed rate, and depth of cut. CNC milling machines often have built in programs, referred to as canned cycle programs which translate these input parameters into control signals to guide the cutting tool around the stock material. Alternatively, specific programs are generated for determining the cuts to be made. Typically, the parameters used to guide the cutting tool are a function of the cutting tool design parameters and the desired cut. It has been discovered that the shape of the scrap which is milled when consistent parameters are used is very consistent. Accordingly, by controlling the feed rate and the speed of rotation as well as the travel path of the cutting tool relative to the stock material in accordance with the present invention, metallic fibers of consistent length, width and depth may be milled from one or more pieces of stock material.

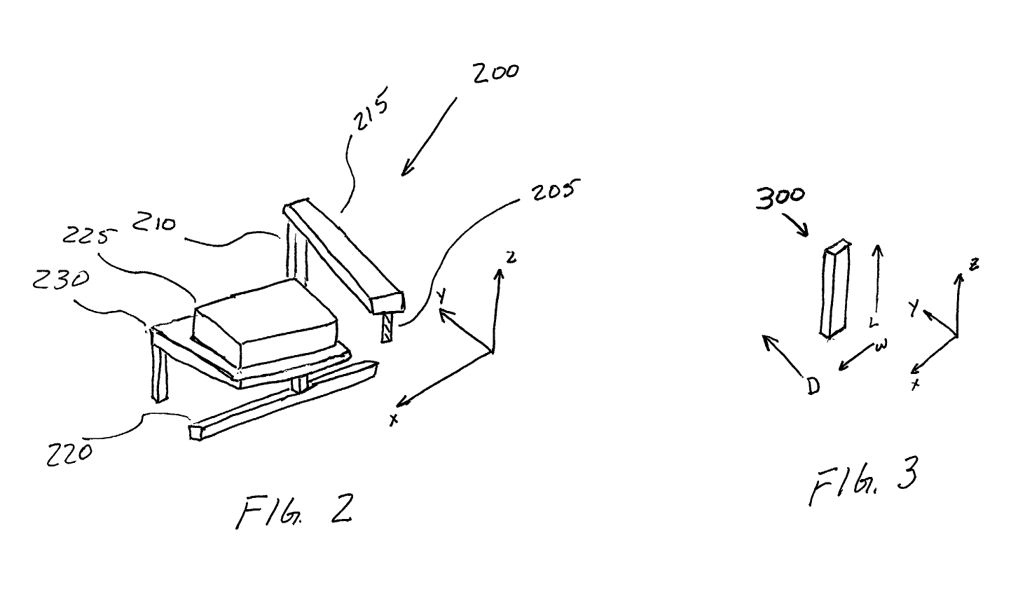

Referring to FIG. 2, a typical CNC milling machine is shown. Milling machine 200 comprises cutting tool 205. Cutting tool 205 is controlled in the Z axis by telescoping control arm 210 and in the Y axis by telescoping control arm 215. Control of cutting tool 205 in the X axis is effected by movement of telescoping control arm 210 along track 220. Stock material 225 is located on table 230.

Those of skill in the milling art will understand that CNC milling machine 200 may be programmed so as to cut entirely around the circumference of stock material 225. Thus, travel speed, which is the speed of the cutting tool in the direction of the travel path, may at times be defined as the speed of cutting tool 205 in the X axis or in the Y axis. Moreover, those of skill in the milling art will understand that the present invention may be practiced with a variety of different milling machines, such as machines which move the position of the stock material either alone or in conjunction with controlling the position of the cutting tool and the cutting bed. The salient characteristic is the ability to control the relative positions and rate of position change of the stock material and the cutting tool so as to realize fibers of the desired parameters.

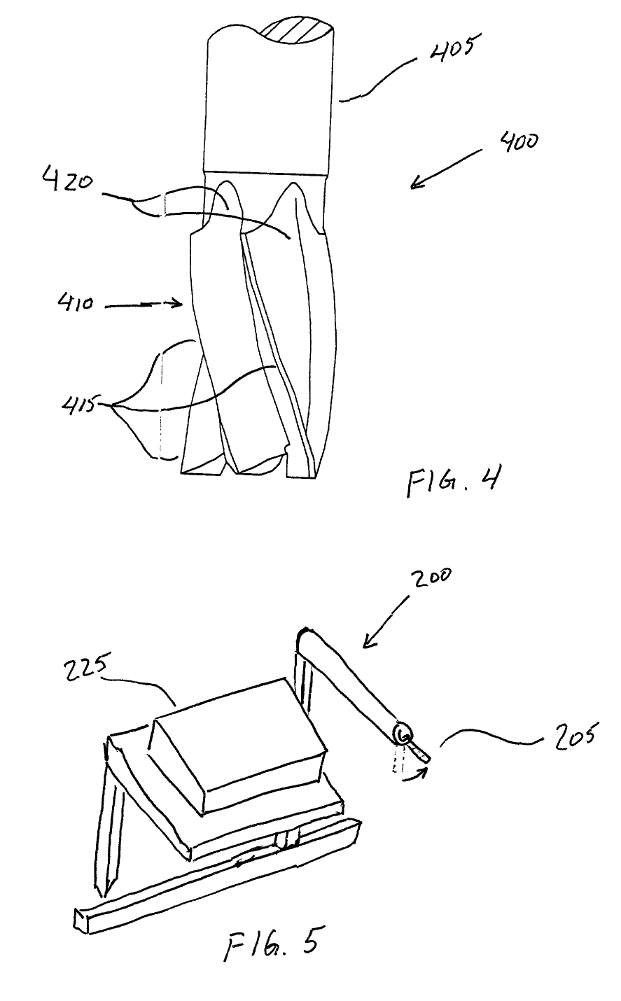

A typical cutting tool is described by reference to FIG. 4. Cutting tool 400 includes generally cylindrical shank 405, joined to cutting section 410. The surface of cutting section 410 has formed into it a plurality of cutting edges 415. Each of cutting edges 415 is separated from the next by flutes 420. In one embodiment, the blades and flutes extend in a helical direction around the body of cutting section 410, as illustrated in FIG. 4. The helical characteristic of a bit, expressed in degrees off of a straight line from the shank to the tip of the tool, is referred to as the pitch of the tool. However, the cutting edges and flutes may take an axial configuration on cutting section 410 wherein cutting edges 415 and flutes 420 extend in a straight line from shank 405 to the bottom of cutting section 410. Bits of this type are referred to as “straight fluted.”

Returning to FIG. 2, as cutting tool 205 mills stock material 225, a fiber will be produced as shown in FIG. 3. Referring to FIG. 3, fiber 300 has a specific length in the Z axis, indicated by arrow L, a specific width in the X axis, indicated by arrow W, and a specific depth in the Y axis, indicated by arrow D. For purpose of explanation, the length of fiber 300 is a function of the thickness of stock material 225 in the Z axis and the manner in which cutting tool 205 engages stock material 225. Thus, according to one embodiment, when cutting tool 205 is perpendicular to stock material 225 and the depth of cut is set so that the entire thickness of stock material 225 is milled by cutting tool 205 in one pass, the length of fiber 300 is equal to the thickness of stock material 225. In this embodiment, the width of fiber 300 is a function of the bite, or amount of material removed, of cutting tool 205 in the axis in which cutting tool 205 is traveling, and the depth of fiber 300 is a function of the cross-bite of cutting tool 205 in the X or Y axis perpendicular to the axis in which cutting tool 205 is traveling. Thus, if cutting tool 205 is traveling in the X axis, then width of fiber 300 is a function of the bite of cutting tool 205 in the X axis, and depth of fiber 300 is a function of the cross-bite of cutting tool 205 in the Y axis.

The desired depth for a particular fiber is a function of the cross-bite of cutting tool 205. Cross-bite is related to a variable used to control the travel path of the cutting tool called “step over.” Typically, “step over” means that after an initial pass past an edge of a stock piece of material has been made, the travel path of the CNC milling machine is controlled in the cross-bite direction in an amount equal to the depth of the fiber manufactured. Thus, on ensuing passes along the piece's edge, additional fibers are manufactured. Accordingly, fiber depth is determined by programming the travel path relative the position of the stock material as is well understood in the milling art. The width of a fiber is a function of the distance traveled by the cutting tool between contact on a stock material by ensuing cutting edges of the cutting tool.

The width is thus used in approximating the desired bite of cutting tool 205 in one embodiment according to the following formula:

T=RFW

wherein

T=travel speed of the cutting tool in inches per minute,

R=rotational speed of the cutting tool in rounds per minute,

F=Number of cutting edges on the cutting tool, and

W=desired width of the fiber.

The optimum speed of rotation of the cutting tool is a function of the cutting tool chosen in conjunction with the bite of cut and the particular stock material as is well known in the art. The number of cutting edges, as such term is described more fully below, is a function of the cutting tool chosen. Accordingly, by inputting the desired fiber width into the above equation, the required travel speed of the cutting tool can be estimated.

The length of the fibers may be controlled in a number of ways. According to one embodiment, a cutting tool is aligned so as to be perpendicular to the stock material as shown in FIG. 2. Accordingly, fibers of a given length may be milled simply by selecting a sheet of stock material with a predetermined thickness corresponding to the desired fiber length. Thus, a 0.25 inch thick sheet of stock metal may be milled, resulting in a fiber of 0.25 inches in length.

Alternatively, the same tool may be inclined relative the selected stock material, by rotating the cutting tool around the Y axis, in order to realize a fiber having a length greater than the predetermined width of the stock material. For example, rotating cutting tool 205 of FIG. 2 by 45 degrees relative the stock material as shown in FIG. 5, results in a fiber which is longer than the stock material is thick. Thus milling the same 1/4 inch sheet of stock metal discussed above will result in a fiber of approximately 0.35 inches in length.

Those of skill in the milling art will understand that the above discussion regarding the determination of the appropriate travel speed and path to obtain desired fiber width and length is simplified. The actual formulae governing the manufacture of fibers is quite complex. For example, as the transfer speed increases, the shape of a fiber is altered. Specifically, as the cutting tool is turning, the cutting tool is also being moved past the stock material. Thus, instead of a generally rectangular straightened fiber shape, the straightened fiber shape is that of a rhomboid. Accordingly, determining the length and width of the fiber is a complicated function of pitch, stock material thickness and travel speed.

Moreover, the fibers will not exhibit perfectly rectangular cross-sections. This is because the cutting tool is round. Accordingly, each cutting edge of the cutting tool will remove a curved piece of material from the piece of stock material. Therefore, as fibers are formed from stock material, the fibers will be square (thicker) at the edge away from the stock material and narrower at the edge closest to the stock material.

Additionally, the fiber shape will be affected by the stock being milled. For example, harder stock will tend to deflect the cutting tool, altering the shape of the fiber. Nonetheless, those of skill in the art will appreciate that careful selection of the stock material and the cutting tool in conjunction with use of the above approximations to determine the proper machining parameters allows the production of fibers which consistently display the desired length, width and depth.

While zero pitch cutting tools may be used in milling machines, those of skill in the milling art understand that it is typically preferred to use cutting tools with some pitch. Fibers milled with cutting tools having a pitch tend to be “twisted and curled.” It is believed that the curl results from the fact that as the fiber is being milled, the cutting tool first contacts the stock material at the top right hand portion of the stock material, and then slices off the fiber downward and to the left hand side of the fiber. As the cutting tool rotates through its cutting motion, the portion of the fiber initially cut is forced away from the stock material. The separation of the fiber from the stock material continues until the bottom portion of the fiber is cut, resulting in a curled fiber.

FIG. 6. is a representation of curled fiber 600 and straightened fiber 605. In practice, the fibers will be curled throughout the length of the fibers, however fiber 600 is only shown curled between arrow 610 and arrow 615 for purpose of discussion. Fiber 605 is shown as straightened for purpose of discussion. Fiber 605 has straightened width indicated by arrow W and straightened depth indicated by arrow D. If a measurement is taken on a curled fiber, such as between arrow 620 and arrow 625, however, the measurement can be referred to as the curled diameter of the fiber. The curled diameter is actually a measure of the fiber diameter where the fiber is twisted. If the fiber were cut at any point and measured in the plane of the cut, the width and depth would be the same as a straightened fiber. By measuring across a twist, the curled diameter is typically a value between the straightened width and the straightened depth. As the fiber is more heavily curled, the curled diameter will approach the value of the smaller dimension, either the width or the diameter.

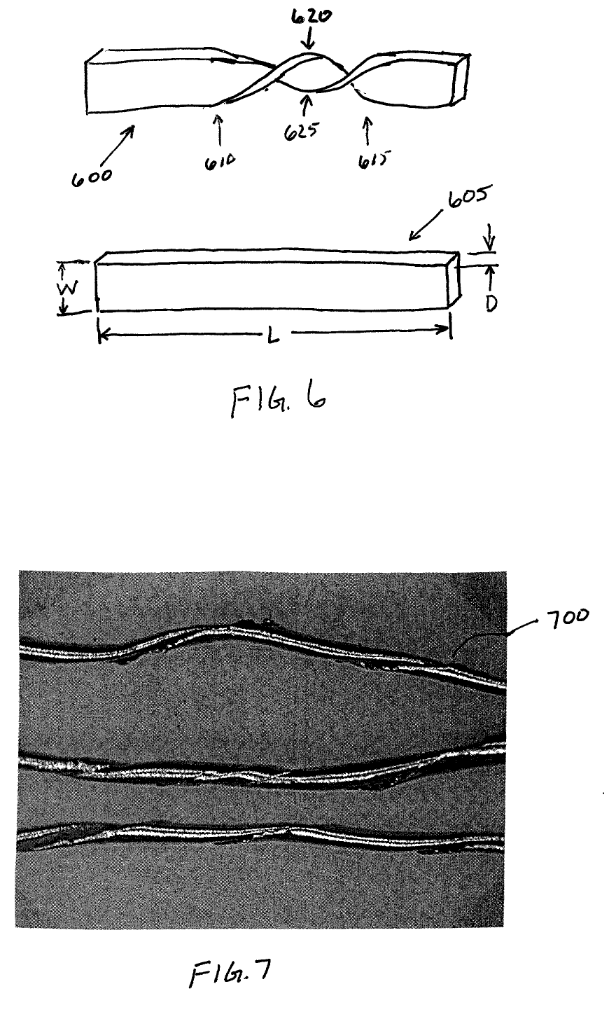

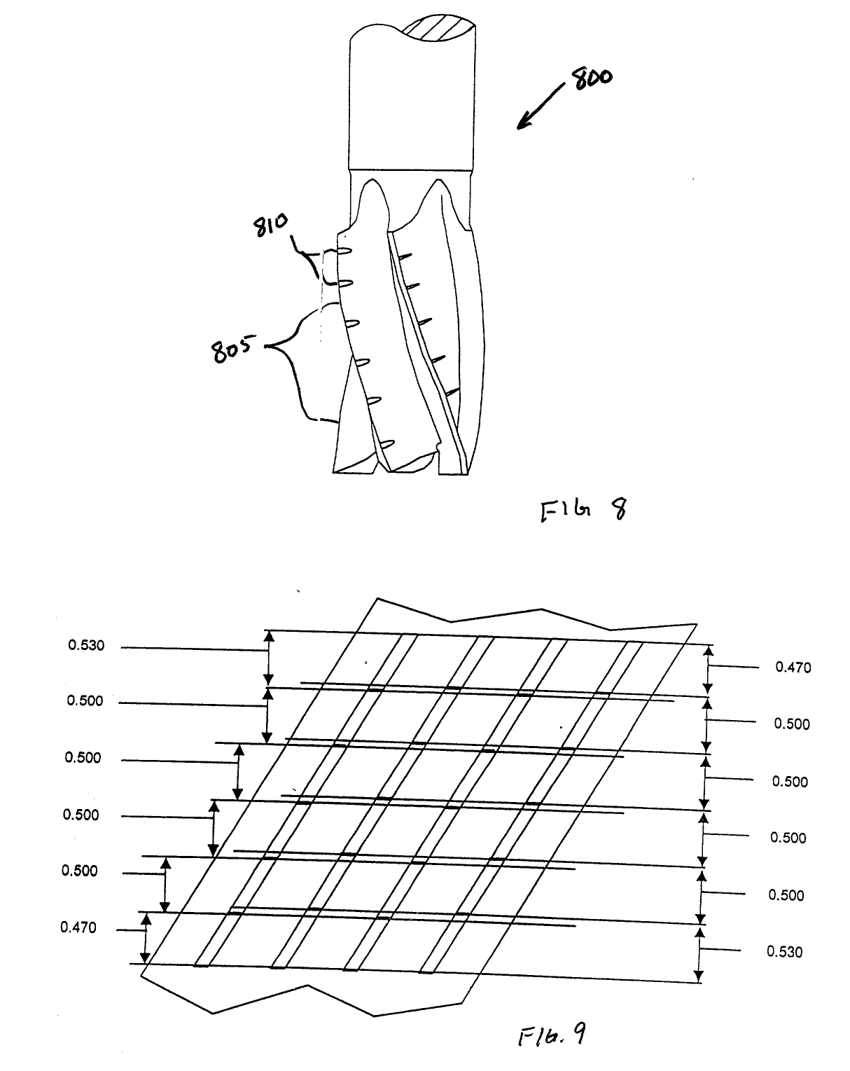

It is believed that the twist results from the fact that as the fibers are being cut, they travel into the flutes of the cutting tool and are twisted as the cutting tool rotates. The twisting effect is observable in FIG. 7 which is a macrograph of metallic fibers made according to the present invention. Fiber 700 is clearly curled as was illustrated by fiber 605 in FIG. 6. Fiber 700 is also twisted such that it is not totally straight. The twist and curl of the metallic fibers is believed to be very beneficial when forming non-woven mats as will be discussed below.

Milling a single sheet of stock material is normally not cost effective, as a significant amount of the cutting tool is not engaged in cutting the stock material. Thus, in accordance with one embodiment of the present invention, a number of sheets may be stacked one on top of the other, so that multiple fibers are cut simultaneously. Obviously, the sheets may be of uniform width or of varied width, depending on the particular application. Accordingly, the fibers made in a single milling operation can be uniform in length or a mix of various lengths depending upon what is desired.

Finally, it is also possible to control the depth of cut into the stock material by controlling the cutting tool in the Z axis. Accordingly, fibers may be cut to a length less than the thickness of the stock material. These variations and others being within the scope of the present invention.

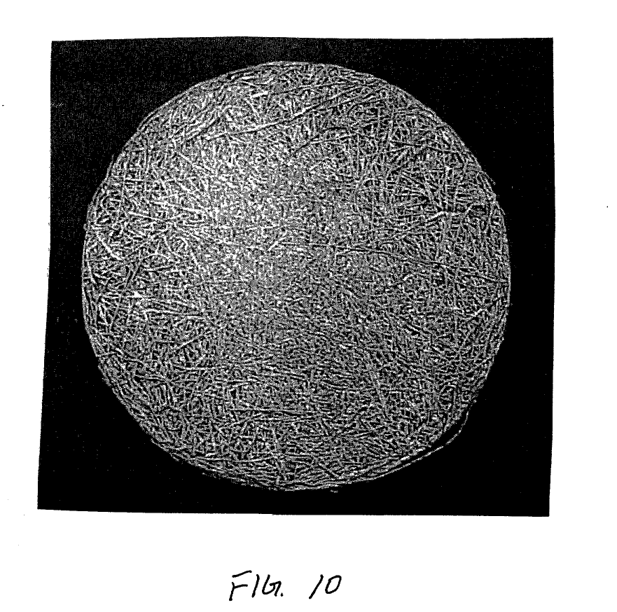

FIG. 8 shows an alternative embodiment of a cutting tool that can be used in practicing the present invention. In this embodiment, cutting tool 800 has cutting edges 805. Each of cutting edges 805 has a plurality of notches 810. As each of notches 810 rotates past a piece of stock material, the stock material is not cut. Thus, each of notches 810 defines the terminus of a fiber being cut by a given cutting edge and the origin of the ensuing fiber to be cut by the cutting edge. Accordingly, notches 810 are cut into cutting edges 805 at a spacing corresponding to the desired fiber length. Thus, if a 0.5 inch fiber is desired, then notches on any given cutting edge will be spaced at 0.5 inch intervals as is shown in FIG. 9, which is a laid open view of cutting tool 800. Moreover, referring still to FIG. 9, the notches on each ensuing cutting edge are slightly offset from the notches on the preceding cutting edge so that any ridge that remains from the prior cut is erased by the ensuing cut. This maintains a smooth stock material, so that additional milling passes may be performed.

Of course, the depth of the notch must be greater than the cross-bite in order to produce separate fibers. Therefore, if the depth of the fiber is to be 0.0015 inches, the notch must be deeper than 0.0015 inches in order to manufacture more than one fiber by the same cutting edge over a single rotation of the cutting tool. In practice, it has been found that the notches can be cut approximately 0.015 inches deep when it is desired to produce a fiber with a depth of 0.0012 inches. Moreover, the notches should be approximately 0.03 inches wide. Thus, when it is desired to cut a 0.5 inch fiber with a four fluted cutting tool, the top notch on the first and third cutting edge will be 0.47 inches from the top of the cutting section and bottom notch will be 0.53 inches from the bottom of the cutting section. The top and bottom fibers cut from a piece of stock material will thus alternate between 0.47 inches and 0.53 inches while the intermediate fibers will be 0.50 inches.

Because the travel path can be finely controlled, it is possible to create fibers of extremely small depth. Accordingly, by controlling the travel speed and path, and by using a bit with closely spaced notches, typically referred to as a “roughing end-mill bit,” such as can be found in Series 114, Item 11475000 end mills commercially available from M. A. Ford Manufacturing Company, Inc. of Davenport Iowa or a model SR 240, EDP 76193 end mill commercially available from Niagara Cutter of Amherst N.Y., it is possible to create fibers that are of a powder size. Fibers made in this fashion are a significant improvement over prior art powders, since the fibers are much more consistent in size, prior art powders typically being formed by atomization and sieving, which is an inherently random process.

As is known in the art, certain cutting tools have a high iron content. However, as a cutting tool operates against the stock material, some of the cutting tool material is actually deposited into the stock material. Thus, when contamination of the fibers is of concern, such as when making battery fibers, it is preferred to use a cutting tool with lower amounts of iron. According to one embodiment, the cutting tool is made of carbide so as to minimize iron contamination of the fibers. Of course, the cutting tool may be made from other materials such as ceramics, such alternative cutting tools being within the scope of the present invention.

Once a sufficient amount of fibers has been produced, the fibers can be formed into other products. It is known, for example, to produce non-woven mats of metal fibers for use in various applications. Alternatively, the fibers may be compacted into a desired form. Fibers made in accordance with the present invention are particularly well suited for being pressed into a desired shape. As was noted above, fibers according to the present invention are twisted and curled. Thus, when the fibers are compacted, they tend to become firmly intertwined. Under the appropriate conditions, it is possible for the fibers to become pressure welded to each other, providing strength and increased conductivity. The curl of the fibers is very conducive to this phenomenon, as the edges of the fiber present a reduced surface area for transfer of the compressive forces.

According to one embodiment, molds are designed in accordance with the desired shape of the electrode. A typical mold system comprises a female mold which is used to contain and form the metal fibers, a bottom plug, and a male compression plunger which compresses the fibers to the desired porosity and shape. A removal plunger is provided to eject the formed electrode from the female mold. In applications where an insert such as brass or copper is desired, the female mold comprises two pieces so as to allow the mesh to be inserted on top of some fibers and beneath other fibers before the fibers are pressed into the desired shape. FIG. 10 is a macrograph of fibers according to the present invention after the fibers have been compressed in a mold. The extensive amount of intertwining of the fibers results in a molded product that is extremely porous, and yet has excellent connectivity between the fibers. The excellent connectivity is a function of the contacts between fibers, each fiber being in contact with a large number of other fibers. Moreover, it is believed that the use of fibers, especially when compacted, provides a cell which can withstand a significant amount of shock without a significant loss in connectivity. Fibers of about 0.5 inches and up to 0.75 inches in length provide excellent connectivity and resilience to shock. Fibers of lengths greater than about 0.75 inches become increasingly more difficult to separate into the amount of fiber needed for a desired porosity.

According to one embodiment, the desired porosity of the resulting product is determined by computing the volume of the mold used to form the product. An appropriate amount of fiber is then loaded into the mold. The amount of fiber to be compressed is determined according to the following formula:

G=KV(1−P)

Wherein

G=Weight of metal fibers in grams,

K=Constant relating the volume occupied by one gram of the metal from which fibers have been manufactured expressed in gram/cubic inch,

V=Volume of mold in cubic inches, and

P=Desired porosity of the compressed product expressed as a volume percent of air.

The fibers are placed into the female portion of a mold and evenly spread across the mold. The male portion of the mold is then forced against the fibers, until the desired compression is achieved. Those of skill in the appropriate art will understand that in addition to compressing the fibers, heat may be added so as to increase the bond between the fibers and to lower the compaction pressure that is necessary to achieve a desired porosity as compared to compaction at room temperature. This and other variations being within the scope of the present invention.

### EXAMPLE 1

Fibers where made according to the present invention by utilizing a model MTV 815/120 CNC milling machine, commercially available from Mazak Corp. of Florence, Ky. The cutting tool used was a 3/4 inch 1856 carbide end mill, commercially available from IMCO Carbide Tool, Inc. of Perrysburg Ohio, having eight flutes and eight cutting edges. Notches were ground into the cutting edges of the cutting tool 0.015 inches deep and approximately 0.03 inches wide. The top notch on the first and third cutting edge was ground 0.47 inches from the top of the cutting section and bottom notch was 0.53 inches from the bottom of the cutting section.

A one inch thick sheet of zinc metal type Alltrista Alloy 615, commercially available from Alltrista Zinc Products Company, L.P. of Greeneville Tenn., was used as a stock material. Thus, each cutting edge produced 2 fibers per cutting tool rotation. The CNC was programmed for travel speed of 459 inches per minute with a cross bite of 0.0015 inches. The cutting tool was set at a rotational speed of 5750 RPM. Accordingly, it is estimated that 92,000 fibers were produced per minute of milling and stock material was consumed at a rate of 10.7 pounds per hour. The fibers had a length of approximately 0.5 inches, a width of 0.017 inches and a depth of 0.0009 inches.

Based upon these numbers, it is believed that large scale production of fibers having consistent length, width and depth is possible. For example, a 24 fluted end-mill set at 3000 RPM on a six inch slab of stock material and a travel speed of 1050 inches per minute is expected to produce 864,000 fibers per minute. The fibers would be 0.5 inches in length, 0.024 inches in width and 0.0009 inches in depth. It is expected that stock material would be used at a rate of 147 pounds per hour.

### EXAMPLE 2

Fibers were manufactured by stacking sheets of zinc and milling the stacked sheets. The sheets were approximately 0.25 inches thick. The sheets were milled with a 5/8 inch series 1290 end mill available from IMCO Carbide Tool, Inc. Some of the resulting fibers were measured using a digital micrometer to obtain approximate length measurements. The results are shown in the following table.

| Fiber | Length (in.) |
|---|---|
| 1 | 0.2961 |
| 2 | 0.3055 |
| 3 | 0.3102 |
| 4 | 0.3102 |
| 5 | 0.3102 |
| 6 | 0.3102 |
| 7 | 0.3102 |
| 8 | 0.3149 |
| 9 | 0.3055 |
| 10 | 0.3290 |
| Average | 0.3102 |
| Std. Dev. | 0.0083 |

As expected, based upon the above discussion of the determination of fiber length, the actual length of the fibers was greater than the 0.25 inch thickness of the stock material. Another group of fibers were measure using a digital micrometer to obtain approximate width measurements. The results are shown in the following table.

| Fiber | Width (in.) |
|---|---|
| 1 | 0.0180 |
| 2 | 0.015 |
| 3 | 0.015 |
| 4 | 0.0225 |
| 5 | 0.0165 |
| 6 | 0.0225 |
| 7 | 0.0180 |
| 8 | 0.0135 |
| 9 | 0.0150 |
| 10 | 0.0165 |
| Average | 0.0173 |
| Std. Dev. | 0.0031 |

Some of the resulting fibers were measured using a digital micrometer to obtain approximate thickness measurements. The results are shown in the following table.

| Fiber | Thickness (in.) |
|---|---|
| 1 | 0.0015 |
| 2 | 0.0020 |
| 3 | 0.0015 |
| 4 | 0.0015 |
| 5 | 0.0010 |
| 6 | 0.0010 |
| 7 | 0.0015 |
| 8 | 0.0020 |
| 9 | 0.0015 |
| 10 | 0.0015 |
| Average | 0.0015 |
| Std. Dev. | 0.0003 |

Finally, some fibers were measured for curled diameter using the same digital micrometer. The results are shown in the following table.

| Fiber | Curled Dia. (in.) |
|---|---|
| 1 | 0.0135 |
| 2 | 0.0120 |
| 3 | 0.0105 |
| 4 | 0.0090 |
| 5 | 0.0075 |
| 6 | 0.0075 |
| 7 | 0.0090 |
| 8 | 0.0075 |
| 9 | 0.0075 |
| 10 | 0.0105 |
| Average | 0.0095 |
| Std. Dev. | 0.0021 |

As stated above, a digital micrometer was used to obtain the above measurements. If desired, more precise measurements may be obtained with other devices. Once measurements have been obtained with an appropriate degree of precision, the milling of fibers may be easily modified so as to realize fibers of the desired measurements as is well understood by those of skill in the art.

### EXAMPLE 3

Fibers made in accordance with the present invention were formed into electrochemical cell anodes. A pressing machine was fitted with a round mold. The female mold was formed such that the formed electrode would have a diameter of 1.2 inches and a thickness of 0.14 inches. The desired porosity was 76%, thus 4.5 grams of zinc fibers were placed into the female mold, and pressed to a thickness of 0.14 inches.

What is claimed is:

1. A plurality of metallic fibers, the fibers being manufactured by milling.

2. The fibers of claim 1, wherein the mill has been controlled so as to produce fibers of a consistent width, depth and length.

3. The fibers of claim 2, the fibers being milled from at least one piece of stock material by a computer number control (CNC) milling machine controllable in an X-axis, a Y-axis and a Z-axis.

4. The fibers of claim 3, wherein the CNC milling machine comprises a cutting tool, and wherein the position of the cutting tool in the X-axis is controlled relative the at least one piece of stock material so as to produce fibers of a consistent width.

5. The fibers of claim 3, wherein the CNC milling machine comprises a cutting tool, and wherein the position of the cutting tool in the Y-axis is controlled relative the at least one piece of stock material so as to produce fibers of a consistent depth.

6. The fibers of claim 3, wherein the at least one piece of stock material is of a predetermined thickness and the length of the fibers being milled by the CNC milling machine is a function of the thickness of the at least one piece of stock material.

7. The fibers of claim 6, wherein the at least one piece of stock material comprises a plurality of pieces of stock material, each of the plurality of pieces of stock material having a predetermined thickness and the length of the fibers being milled by the CNC milling machine is a function of the thicknesses of the plurality of pieces of stock material.

8. The fibers of claim 3, wherein the CNC milling machine comprises a cutting tool, and wherein:
the position of the cutting tool in the Y-axis is controlled relative the at least one piece of stock material so as to produce fibers of a consistent depth; and
the position of the cutting tool in the X-axis is controlled relative the at least one piece of stock material so as to produce fibers of a consistent width.

9. The fibers of claim 8, wherein the CNC milling machine comprises a generally cylindrical cutting tool, the cutting tool comprising:
at least one helically disposed cutting edge on the outer periphery of the cutting tool, and
at least one notch in the cutting edge, the notch of a depth exceeding the cross-bite of the cutting tool when the cutting tool is milling a piece of stock material, so that as the notch rotates over the piece of stock material, the piece of stock material is not cut by the cutting edge at the location of the at least one notch, such that the length of the fibers being milled is a function of the location of the notch on the cutting edge relative to the piece of stock material.

10. The fibers of claim 9, the fibers having a length between about 0.012 inches and about 6 inches.

11. The fibers of claim 10, the fibers having a length between about 0.125 inches and about 0.75 inches.

12. A battery plate for use in an electro chemical cell and the like, comprising:
a plurality of fibers in conductive contact one with another, the plurality of fibers being manufactured by milling.

13. The battery plate of claim 12, wherein the mill has been controlled so as to produce fibers of a consistent width, depth and length.

14. The battery plate of claim 13, the fibers being milled from at least one piece of stock material by a computer number control (CNC) milling machine controllable in an X-axis, a Y-axis and a Z-axis.

15. The battery plate of claim 14, wherein the CNC milling machine comprises a cutting tool, and wherein the position of the cutting tool in the X-axis is controlled relative the at least one piece of stock material so as to produce fibers of a consistent width.

16. The battery plate of claim 14, wherein the CNC milling machine comprises a cutting tool, and wherein the position of the cutting tool in the Y-axis is controlled relative the at least one piece of stock material so as to produce fibers of a consistent depth.

17. The battery plate of claim 14, wherein the at least one piece of stock material is of a predetermined thickness and the length of the fiber being milled by the CNC milling machine is a function of the thickness of the at least one piece of stock material.

18. The fibers of claim 17, wherein the at least one piece of stock material comprises a plurality of pieces of stock material, each of the plurality of pieces of stock material having a predetermined thickness and the length of the fibers being milled by the CNC milling machine is a function of the thicknesses of the plurality of pieces of stock material.

19. The battery plate of claim 14, wherein the CNC milling machine comprises a cutting tool, and wherein:
the position of the cutting tool in the Y-axis is controlled relative the at least one piece of stock material so as to produce fibers of a consistent depth; and
the position of the cutting tool in the X-axis is controlled relative the at least one piece of stock material so as to produce fibers of a consistent width.

20. The battery plate of claim 19, wherein the CNC milling machine comprises a generally cylindrical cutting tool, the cutting tool comprising:
at least one helically disposed cutting edge on the outer periphery of the cutting tool, and
at least one notch in the cutting edge, the notch of a depth exceeding the cross-bite of the cutting tool when the cutting tool is milling a piece of stock material, so that as the notch rotates over the piece of stock material, the piece of stock material is not cut by the cutting edge at the location of the at least one notch, such that the length of the fibers being milled is a function of the location of the notch on the cutting edge relative to the piece of stock material.

21. The battery plate of claim 20, the fiber having a length between about 0.012 inches and about 6 inches.

22. The battery plate of claim 21, the fiber having a length between about 0.125 inches and about 0.75 inches.

23. A battery plate according to claim 20, wherein the CNC milling machine comprises a generally cylindrical carbide cutting tool.

24. A battery plate according to claim 23, wherein the at least one piece of stock material comprises zinc.

25. A method of manufacturing a metallic fiber, the method comprising the following steps:
providing at least one piece of stock material; and
milling from the at least one piece of stock material a fiber.

26. The method of claim 25, wherein the step of milling comprises the step of controlling the mill so as to produce fibers of a consistent width, depth and length.

27. The method of claim 26, wherein the step of milling comprises the following steps:
providing a computer number control (CNC) milling machine controllable in an X-axis, a Y-axis and a Z-axis; and
controlling the position of the cutting tool in the X-axis relative the at least one piece of stock material so as to produce fibers of a consistent width.

28. The method of claim 26, wherein the step of milling comprises the following steps:
providing a computer number control (CNC) milling machine controllable in an X-axis, a Y-axis and a Z-axis; and
controlling the position of the cutting tool in the Y-axis relative the at least one piece of stock material so as to produce fibers of a consistent depth.

29. The method of claim 25, wherein the step of providing at least one piece of stock material comprises the step of providing at least one piece of stock material of a predetermined thickness such that the length of the fibers milled by the milling machine is controlled as a function of the thickness of the at least one piece of stock material.

30. The method of claim 29, wherein the step of providing at least one piece of stock material of a predetermined thickness comprises the step of providing at least one piece of stock material of a predetermined thickness between about 0.012 inches and about 6 inches.

31. The method of claim 29, wherein the step of providing at least one piece of stock material comprises the step of providing a plurality of pieces of stock material, each of the plurality of pieces of stock material having a predetermined thickness such that the length of the fibers being milled by the CNC milling machine is a function of the thicknesses of the plurality of pieces of stock material.

32. The method of claim 26, wherein the step of milling comprises the following steps:
providing a computer number control (CNC) milling machine controllable in an X-axis, a Y-axis and a Z-axis; and
controlling the CNC milling machine in the Y-axis relative the at least one piece of stock material so as to produce fibers of a consistent depth; and
controlling the CNC milling machine in the X-axis relative the at least one piece of stock material so as to produce fibers of a consistent width.

33. The method of claim 32, wherein the step of milling comprises the following steps:
providing a generally cylindrical cutting tool in the CNC milling machine controllable in the Z-axis, the cutting tool comprising:
at least one helically disposed cutting edge on the outer periphery of the cutting tool, and
at least one notch in the cutting edge, the notch of a depth exceeding the cross-bite of the cutting tool when the cutting tool is milling a piece of stock material, so that as the notch rotates over the piece of stock material, the piece of stock material is not cut by the cutting edge at the location of the at least one notch; and
controlling the CNC milling machine in the Z axis so as to produce fibers of a consistent length as a function of the location of the notch on the cutting edge relative to the at least one piece of stock material.

34. The method of claim 33, wherein the step of controlling the CNC milling machine in the Z axis comprises the step of controlling the length of the fibers to be between about 0.125 inches and about 0.75 inches.

35. A method of manufacturing an electrode for use in an electrochemical cell and the like, the method comprising the following steps:
providing fibers milled from a piece of stock material; and
forming from the fibers an electrode.

36. The method of claim 35, step of providing fibers comprising the following steps:
providing at least one piece of stock material; and
milling from the at least one piece of stock material a fiber.

37. The method of claim 36, wherein the step of milling comprises the step of controlling the mill so as to produce fibers of a consistent width, depth and length.

38. The method of claim 37, wherein the step of milling comprises the following steps:
providing a computer number control (CNC) milling machine controllable in an X-axis, a Y-axis and a Z-axis; and
controlling the position of the cutting tool in the X-axis relative the at least one piece of stock material so as to produce fibers of a consistent width.

39. The method of claim 37, wherein the step of milling comprises the following steps:
providing a computer number control (CNC) milling machine controllable in an X-axis, a Y-axis and a Z-axis; and
controlling the position of the cutting tool in the Y-axis relative the at least one piece of stock material so as to produce fibers of a consistent depth.

40. The method of claim 36, wherein the step of providing at least one piece of stock material comprises the step of providing at least one piece of stock material of a predetermined thickness such that the length of the fibers milled by the milling machine is controlled as a function of the thickness of the at least one piece of stock material.

41. The method of claim 40, wherein the step of providing at least one piece of stock material of a predetermined thickness comprises the step of providing at least one piece of stock material of a predetermined thickness between about 0.012 inches and about 6 inches.

42. The method of claim 40, wherein the step of providing at least one piece of stock material comprises the step of providing a plurality of pieces of stock material, each of the plurality of pieces of stock material having a predetermined thickness such that the length of the fibers being milled by the CNC milling machine is a function of the thicknesses of the plurality of pieces of stock material.

43. The method of claim 37, wherein the step of milling comprises the following steps:
providing a computer number control (CNC) milling machine controllable in an X-axis, a Y-axis and a Z-axis; and
controlling the CNC milling machine in the Y-axis relative the at least one piece of stock material so as to produce fibers of a consistent depth; and
controlling the CNC milling machine in the X-axis relative the at least one piece of stock material so as to produce fibers of a consistent width.

44. The method of claim 43, wherein the step of milling comprises the following steps:
providing a generally cylindrical cutting tool in the CNC milling machine controllable in the Z-axis, the cutting tool comprising:
at least one helically disposed cutting edge on the outer periphery of the cutting tool, and
at least one notch in the cutting edge, the notch of a depth exceeding the cross-bite of the cutting tool when the cutting tool is milling a piece of stock material, so that as the notch rotates over the piece of stock material, the piece of stock material is not cut by the cutting edge at the location of the at least one notch; and
controlling the CNC milling machine in the Z axis so as to produce fibers of a consistent length as a function of the location of the notch on the cutting edge relative to the at least one piece of stock material.

45. The method of claim 44, wherein the step of controlling the CNC milling machine in the Z axis comprises the step of controlling the length of the fibers to be between about 0.125 inches and about 0.75 inches.

46. The method of claim 37, wherein, the step of forming from the fibers an electrode comprises the steps of:
providing a pressing machine; and
pressing the fibers with the pressing machine into an electrode.

47. The method of claim 46, wherein the step of providing a pressing machine comprises the step of selecting a mold to be used in the pressing machine, the mold being in the shape of an electrode for use in a cell from the following group of cells:
a button cell;
a cylindrical cell;
a wafer cell;
a rectangular cell; and
a flat cell, and wherein the step of pressing the fibers comprises the step of pressing the fibers into an electrode for use in a cell corresponding to the mold shape selected.
